(19) United States
(12) Patent Application Publication
(10) Pub. No.: US 2024/0264591 A1
(43) Pub. Date: Aug. 8, 2024

(54) HEALTH MONITORING FOR HYDRAULIC EQUIPMENT COMPONENTS

(71) Applicant: Chevron U.S.A. Inc., San Ramon, CA (US)

(72) Inventors: Richard Alan Cummings, Houston, TX (US); James David Pate, New Ulm, TX (US); Alisha DeAun Pate, New Ulm, TX (US)

(21) Appl. No.: 18/431,316

(22) Filed: Feb. 2, 2024

Related U.S. Application Data
(60) Provisional application No. 63/442,908, filed on Feb. 2, 2023.

(51) Int. Cl. G05B 23/02; G06Q 10/20

(52) U.S. Cl. CPC G05B 23/0283; G06Q 10/20

(57) ABSTRACT

An equipment health model is generated for a piece of hydraulic equipment using operating characteristic(s) of the piece of hydraulic equipment and status of the piece of hydraulic equipment. The equipment health model uses fingerprints (initial signatures of the equipment) and key inputs (pressure, temperature, time durations, gallon counts to actuate, etc.) in the operating characteristic(s) of the piece of hydraulic equipment to determine health of the piece of hydraulic equipment. Specific patterns/trends in the operating characteristic(s) of the piece of hydraulic equipment are used as leading indicator to measure, alert, and alarm on the health of the piece of hydraulic equipment. The alerts are escalated to personnel to ensure the equipment health is proactively addressed.

### CROSS-REFERENCE TO RELATED APPLICATIONS

The present application claims the benefit of U.S. Provisional Application Number 63/442,908, entitled “HEALTH MONITORING FOR HYDRAULIC EQUIPMENT COMPONENTS,” which was filed on: Feb. 2, 2023, the entirety of which is hereby incorporated herein by reference.

### FIELD

The present disclosure relates generally to the field of monitoring health of hydraulic equipment components.

### BACKGROUND

Hydraulically operated equipment may include components (e.g., rubber parts) that are fatigued during operation and eventually fail. Failure of such components may lead to inefficient or unsafe operations, out-of-compliance issues with regulators, downtime, and/or failure of the system as a whole.

### SUMMARY

This disclosure relates to monitoring health of hydraulic equipment components. Sensor information for a piece of hydraulic equipment, status information for the piece of hydraulic equipment, and/or other information may be obtained. The sensor information may characterize one or more operating characteristics of the piece of hydraulic equipment over a period of time. The status information may characterize status of the piece of hydraulic equipment over the period of time. An equipment health model for the piece of hydraulic equipment may be generated based on the sensor information, the status information, and/or other information. The equipment health model may receive as input the operating characteristic(s) of the piece of hydraulic equipment. The equipment health model may provide as output the status of the piece of hydraulic equipment. The equipment health model for the piece of hydraulic equipment may be stored in a storage medium.

Usage information for the piece of hydraulic equipment and/or other information may be obtained. The usage information may characterize the operating characteristic(s) of the piece of hydraulic equipment for a duration of time. The usage information may be input into the equipment health model for the piece of hydraulic equipment, and the equipment health model may output the status of the piece of hydraulic equipment. Health monitoring for the piece of hydraulic equipment based on the status of the piece of hydraulic equipment output by the equipment health model may be facilitated.

A system for monitoring health of hydraulic equipment components may include one or more electronic storage, one or more processors and/or other components. The electronic storage may store sensor information, status information, usage information, information relating to a piece of hydraulic equipment, information relating to operating characteristics of the piece of hydraulic equipment, information relating to status of the piece of hydraulic equipment, information relating to equipment health model, information relating to health monitoring for the piece of hydraulic equipment, and/or other information.

The processor(s) may be configured by machine-readable instructions. Executing the machine-readable instructions may cause the processor(s) to facilitate monitoring health of hydraulic equipment components. The machine-readable instructions may include one or more computer program components. The computer program components may include one or more of a sensor component, a status component, a model component, a storage component, a usage component, a health component, a monitoring component, and/or other computer program components.

The sensor component may be configured to obtain sensor information for a piece of hydraulic equipment and/or other information. The sensor information may characterize one or more operating characteristics of the piece of hydraulic equipment over a period of time. In some implementations, the operating characteristic(s) of the piece of hydraulic equipment may include pressure, fluid flow rate, fluid volume, gallon count, open/closure count, actuation duration, and/or temperature. In some implementations, the operating characteristic(s) of the piece of hydraulic equipment may further include sound. In some implementations, the piece of hydraulic equipment may include an elastomer component.

The status component may be configured to obtain status information for the piece of hydraulic equipment and/or other information. The status information may characterize status of the piece of hydraulic equipment over the period of time.

The model component may be configured to generate an equipment health model for the piece of hydraulic equipment. The equipment health model for the piece of hydraulic equipment may be generated based on the sensor information, the status information, and/or other information. The equipment health model may receive as input the operating characteristic(s) of the piece of hydraulic equipment. The equipment health model may provide as output the status of the piece of hydraulic equipment.

In some implementations, the equipment health model may include one or more regression models, one or more machine-learning models, and/or other models.

The storage component may be configured to store the equipment health model for the piece of hydraulic equipment. The equipment health model for the piece of hydraulic equipment may be stored in a storage medium.

The usage component may be configured to obtain usage information for the piece of hydraulic equipment and/or other information. The usage information may characterize the operating characteristic(s) of the piece of hydraulic equipment for a duration of time.

The health component may be configured to input the usage information into the equipment health model for the piece of hydraulic equipment. The equipment health model may output the status of the piece of hydraulic equipment. In some implementations, the status of the piece of hydraulic equipment may include status of the elastomer component. The status of the elastomer component may include remaining life of the elastomer component. The status of the elastomer component may include one or more defects in the elastomer component. The status of the elastomer component may include prediction on future usage of the elastomer component.

The monitoring component may be configured to facilitate health monitoring for the piece of hydraulic equipment based on the status of the piece of hydraulic equipment output by the equipment health model and/or other information. In some implementations, facilitation of the health monitoring for the piece of hydraulic equipment based on the status of the piece of hydraulic equipment output by the equipment health model may include performance of one or more maintenance operations for the piece of hydraulic equipment based on the status of the piece of hydraulic equipment output by the equipment health model and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for monitoring health of hydraulic equipment components.

FIG. 2A illustrates an example method for monitoring health of hydraulic equipment components.

FIG. 2B illustrates an example method for monitoring health of hydraulic equipment components.

FIG. 3 illustrates an example process for monitoring health of hydraulic equipment components.

### DETAILED DESCRIPTION

The present disclosure relates to monitoring health of hydraulic equipment components. An equipment health model is generated for a piece of hydraulic equipment using operating characteristic(s) of the piece of hydraulic equipment and status of the piece of hydraulic equipment. The equipment health model uses fingerprints (initial signatures of the equipment) and key inputs (pressure, temperature, time durations, gallon counts to actuate, etc.) in the operating characteristic(s) of the piece of hydraulic equipment to determine health of the piece of hydraulic equipment. Specific patterns/trends in the operating characteristic(s) of the piece of hydraulic equipment are used as leading indicators to measure, alert, and alarm on the health of the piece of hydraulic equipment. The alerts are escalated to personnel to ensure the equipment health is proactively addressed. In the event that the first individual/hierarchy doesn't respond and resolve the alarm, the alarm is escalated to the next in progression until the alarm is acknowledged and satisfactorily addressed.

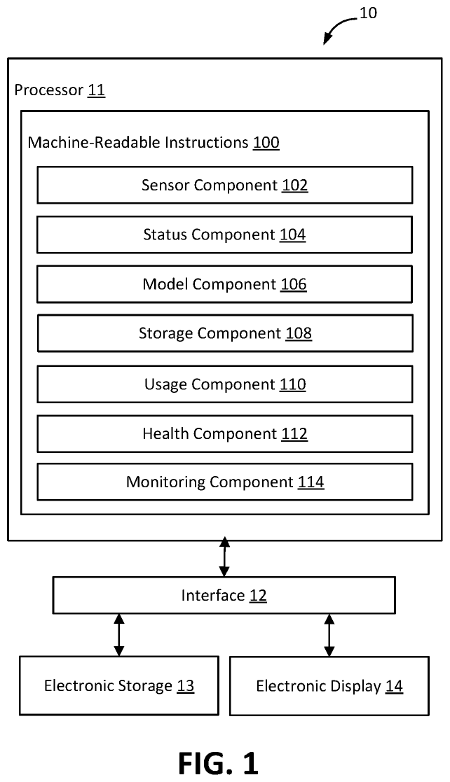

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Sensor information for a piece of hydraulic equipment, status information for the piece of hydraulic equipment, and/or other information may be obtained by the processor 11. The sensor information may characterize one or more operating characteristics of the piece of hydraulic equipment over a period of time. The status information may characterize status of the piece of hydraulic equipment over the period of time. An equipment health model for the piece of hydraulic equipment may be generated by the processor 11 based on the sensor information, the status information, and/or other information. The equipment health model may receive as input the operating characteristic(s) of the piece of hydraulic equipment. The equipment health model may provide as output the status of the piece of hydraulic equipment. The equipment health model for the piece of hydraulic equipment may be stored by the processor 11 in a storage medium.

Usage information for the piece of hydraulic equipment and/or other information may be obtained by the processor 11. The usage information may characterize the operating characteristic(s) of the piece of hydraulic equipment for a duration of time. The usage information may be input into the equipment health model for the piece of hydraulic equipment by the processor 11, and the equipment health model may output the status of the piece of hydraulic equipment. Health monitoring for the piece of hydraulic equipment based on the status of the piece of hydraulic equipment output by the equipment health model may be facilitated by the processor 11.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store sensor information, status information, usage information, information relating to a piece of hydraulic equipment, information relating to operating characteristics of the piece of hydraulic equipment, information relating to status of the piece of hydraulic equipment, information relating to equipment health model, information relating to health monitoring for the piece of hydraulic equipment, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present sensor information, status information, usage information, information relating to a piece of hydraulic equipment, information relating to operating characteristics of the piece of hydraulic equipment, information relating to status of the piece of hydraulic equipment, information relating to equipment health model, information relating to health monitoring for the piece of hydraulic equipment, and/or other information.

Hydraulic equipment may refer to hydraulically operated equipment. Hydraulic equipment may refer to equipment that uses liquid fluid power to perform its function. A piece of hydraulic equipment may refer to a particular hydraulic equipment or a particular component of a hydraulic equipment. For example, a piece of hydraulic equipment may include one or more elastomer components. An elastomer component may refer to a part of hydraulic equipment made of natural and/or synthetic polymer that has elastic properties (e.g., rubber). Hydraulic equipment may be used in exploration and/or recovery of resources in the ground, such as water or hydrocarbons. For example, hydraulic equipment may include hydraulically operated well control equipment.

Operation of hydraulic equipment may result in the hydraulic equipment/components of the hydraulic equipment being fatigued and lead to failure of the hydraulic equipment/components. For example, operation of a hydraulically operated well control equipment including rubber parts may result in the rubber parts being fatigued, eventually leading to failure of the rubber parts. Failure of such components may lead to inefficient or unsafe operations, out-of-compliance issues with regulators, downtime, and/or failure of the hydraulic system.

The present disclosure provides a tool to programmatically implement a predictive and proactive health tracking, trending, alerting, alarming, and escalation of hydraulic equipment. Rather than running a piece of hydraulic equipment to failure, fingerprints/signatures of sensor information (e.g., pressure, fluid flow rate, fluid volume, gallon count, open/closure count, actuation duration, temperature, sound) for the piece of hydraulic equipment are used to quantify, estimate, and/or predict the health of the piece of hydraulic equipment. Specific patterns/trends from the sensor information are used as a leading indicator to measure, alert, and alarm on the health of the piece of hydraulic equipment. For example, pressure trends and equipment operating conditions may show diminishing capability of elastomer seals and/or proactively predict the remaining useful life of elastomer seals.

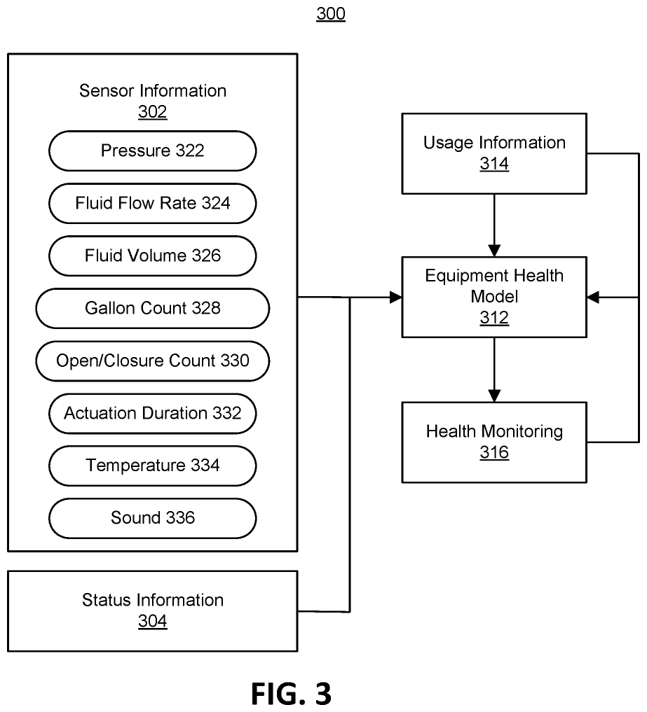

FIG. 3 illustrates an example process 300 for monitoring health of hydraulic equipment components. In the process 300, sensor information 302 and status information 304 for a piece of hydraulic equipment may be used to generate an equipment health model 312 for the piece of hydraulic equipment. The sensor information 302 may include information on operating characteristics of the piece of hydraulic equipment over a period of time, such as pressure 322, fluid flow rate 324, fluid volume 326, gallon count 328, open/closure count 330, actuation duration 332, temperature 334, and/or sound 336. The sensor information 302 may include time-series measurements of operating characteristics of the piece of hydraulic equipment over a period of time. The status information 304 may include information on status of the piece of hydraulic equipment over a period of time, such as state, condition, health, remaining life, defects, and/or prediction on future usage of the piece of hydraulic equipment. The status information 304 may time-series information on the status of the piece of hydraulic equipment over a period of time.

The equipment health model 312 may include one or more regression models, one or more machine-learning models, and/or other models. The regression model(s) may be generated based on known relationship(s) between the operating characteristics and the status of the piece of hydraulic equipment. For example, the regression model(s) may be generated based on specific values and/or specific combination of values of operating characteristics indicating specific status of the piece of hydraulic equipment. The regression model(s) may be generated based on specific patterns/trends in values and/or specific combination of patterns/trends in values of operating characteristics indicating specific status of the piece of hydraulic equipment.

The machine-learning model(s) may be trained based on the operating characteristics and the status of the piece of hydraulic equipment to discover relationship(s) between the operating characteristics and the status of the piece of hydraulic equipment. For example, the machine-learning model(s) may be trained to output specific status of the piece of hydraulic equipment based on specific values and/or specific combination of values of operating characteristics. The machine-learning model(s) may be trained to output specific status of the piece of hydraulic equipment based on specific patterns/trends in values and/or specific combination of patterns/trends in values of operating characteristics.

Usage information 314 for the piece of hydraulic equipment may be input into the equipment health model 312. The usage information 314 may include information on operating characteristics of the piece of hydraulic equipment over a duration of time (different from the period of time in which the sensor information was gathered to generate the equipment health model 312). The duration of time may include current time—time at which operating characteristics were most recently/last measured. The usage information 314 may include most recently measured values of operating characteristics, last measured values of operating characteristics, and/or real-time values of operating characteristics of the piece of hydraulic equipment.

Based on the input usage information 314, the equipment health model 312 may output status of the piece of hydraulic equipment. Based on the input usage information 314, the equipment health model may quantify, estimate, and/or predict the status (e.g., state, condition, health, remaining life, defects, and/or prediction on future usage) of the piece of hydraulic equipment. The equipment health model 312 may use fingerprints/signatures in the usage information 314 to output the status of the piece of hydraulic equipment. The status of the piece of hydraulic equipment output by the equipment health model 312 may enable a user to understand where the piece of hydraulic equipment is operating on the life continuum curve of the equipment.

The status of the piece of hydraulic equipment output by the equipment health model 312 may include the status of the piece of hydraulic equipment for the time of the usage information 314. The equipment health model 312 may output the status of the piece of hydraulic equipment for the same/overlapping time duration as the usage information 314. The status of the piece of hydraulic equipment output by the equipment health model 312 may include the status of the piece of hydraulic equipment for ahead of the time of the usage information 314. The equipment health model 312 may output the status of the piece of hydraulic equipment for a later time (in the future) than the time duration of the usage information 314.

Health monitoring 316 for the piece of hydraulic equipment may be performed using the status of the piece of hydraulic equipment output by the equipment health model 312. Health monitoring 316 for the piece of hydraulic equipment may include presentation of the status of the piece of hydraulic equipment on one or more electronic displays, presentation of information relating to and/or determined from the status of the piece of hydraulic equipment on electronic display(s), tracking the status of the piece of hydraulic equipment over time, performance of one or more maintenance operations for the piece of hydraulic equipment based on the status, and/or other health monitoring of the piece of hydraulic equipment. Health monitoring 316 for the piece of hydraulic equipment may include measuring, alerting, and/or generating alarms on the health of the piece of hydraulic equipment. The alerts may be escalated to personnel to ensure the equipment health is proactively addressed.

Usage information 314 and information from health monitoring 316 may be used to improve/enhance the equipment health model 312. For example, when hydraulic equipment is maintained and disassembled, captured information (e.g., pictures, readings, etc.), along with corresponding usage information 314, may be used to increase the accuracy of the equipment health model 312. For example, more accurate/precise relationship between operating characteristics and status of the piece of hydraulic equipment may be determined for the regression model(s) and/or predictive capabilities of the machine learning model(s) may be enhanced by increasing the amount/quality of training data.

Using the approach of the present disclosure, event management and escalation paths for hydraulic equipment may be implemented to ensure that events for hydraulic equipment (e.g., well control events) are proactively addressed and equipment reliability is improved (e.g., optimized). For example, the present disclosure may reduce (e.g., minimize) well control events and non-productive time for hydraulic equipment used in exploration and/or recovery of resources in the ground.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate monitoring health of hydraulic equipment components. The machine-readable instructions 100 may include one or more computer program components. The machine-readable instructions 100 may include a sensor component 102, a status component 104, a model component 106, a storage component 108, a usage component 110, a health component 112, a monitoring component 114, and/or other computer program components.

The sensor component 102 may be configured to obtain sensor information for a piece of hydraulic equipment and/or other information. Obtaining sensor information may include one or more of accessing, acquiring, analyzing, determining, examining, generating, identifying, loading, locating, measuring, opening, receiving, retrieving, reviewing, selecting, storing, and/or otherwise obtaining the sensor information. The sensor component 102 may obtain sensor information from one or more locations. For example, the sensor component 102 may obtain sensor information from a storage location, such as the electronic storage 13, electronic storage of a device accessible via a network, and/or other locations. The sensor component 102 may obtain sensor information from one or more hardware components (e.g., a computing device, a sensor) and/or one or more software components (e.g., software running on a computing device).

In some implementations, the sensor information may be obtained from one or more users. For example, a user may interact with a computing device to input the sensor information (e.g., upload the sensor information, specify the operating characteristics of the piece of hydraulic equipment).

In some implementations, the sensor information may be obtained from one or more sensors. For example, the sensor component 102 may operate one or more sensors to acquire the sensor information and/or receive the sensor information from the sensor(s). The sensor(s) may include pressure sensor(s), fluid flow rate sensor(s), fluid volume sensor(s), temperature sensor(s), sound sensor(s), and/or other sensors. In some implementation, one or more of the sensors may be part of the hydraulic equipment. For example, the sensor component 102 may use one or more pressure sensors of the hydraulic equipment to obtain pressure readings for the hydraulic equipment. In some implementation, one or more of the sensors may be installed on/for the hydraulic equipment. For example, one or more temperature sensors may be installed on or near the hydraulic equipment to record temperature of the hydraulic equipment operation and/or one or more sound sensors (e.g., microphones) may be installed on or near the hydraulic equipment to record sounds of the hydraulic equipment operation.

The sensor information may characterize one or more operating characteristics of the piece of hydraulic equipment over a period of time. The sensor information may characterize operating characteristic(s) of the piece of hydraulic equipment at different moments within the period of time. For example, the sensor information may include time-series measurements of the operating characteristic(s) of the piece of hydraulic equipment at different time points over the period of time.

The sensor information may characterize an operating characteristic of the piece of hydraulic equipment by defining, describing, identifying, quantifying, reflecting, and/or otherwise characterizing the operating characteristic of the piece of hydraulic equipment. An operating characteristic of a piece of hydraulic equipment may refer to one or more features and/or one or more qualities of the piece of hydraulic equipment during operation (e.g., for exploration and/or recovery of resources). An operating characteristic of a piece of hydraulic equipment may refer to a characteristic of the piece of hydraulic equipment/hydraulic equipment during operation. Operation of the piece of hydraulic equipment may refer to performance of work on and/or usage of the piece of hydraulic equipment.

An operating characteristic of a piece of hydraulic equipment may include one or more values of operating parameter(s) that define the operation of the piece of hydraulic equipment. An operating characteristic of a piece of hydraulic equipment may include status of how the piece of hydraulic equipment is being used. An operating characteristic of a piece of hydraulic equipment may include one or more characteristics of materials of, within, around, and/or near the piece of hydraulic equipment. For example, an operating characteristic of a piece of hydraulic equipment may include characteristic(s) of the piece of hydraulic equipment itself (e.g., geometry of the piece of hydraulic equipment, materials of the piece of hydraulic equipment), characteristic(s) of materials inside the piece of hydraulic equipment (e.g., pressure, temperature, heat transfer characteristics, fluid composition/properties, flow velocity, viscosity of the fluid, density of the fluid), characteristic(s) of materials outside the piece of hydraulic equipment (e.g., sound generated by the piece of hydraulic equipment), and/or other operating characteristic of the piece of hydraulic equipment. An operating characteristic of a piece of hydraulic equipment may include an operating characteristic of the hydraulic equipment.

For example, the operating characteristic(s) of a piece of hydraulic equipment may include pressure, fluid flow rate, fluid volume, gallon count, open/closure count, actuation duration, and/or temperature of the piece of hydraulic equipment/hydraulic equipment. In some implementations, the operating characteristic(s) of the piece of hydraulic equipment may further include sound. Pressure may refer to pressure measured within the piece of hydraulic equipment/hydraulic equipment and/or pressure used to operate the piece of hydraulic equipment/hydraulic equipment. Pressure may include available hydraulic supply pressure, regulated supply pressure, and/or other pressure. Fluid flow rate may refer to fluid velocity measured within the piece of hydraulic equipment/hydraulic equipment and/or fluid velocity used to operate the piece of hydraulic equipment/hydraulic equipment. Fluid volume may refer to the total amount of fluid required to operate the piece of hydraulic equipment/hydraulic equipment. Fluid volume may indicate a valve misalignment and/or other abnormality if the total volume is not accurate. Gallon count may refer to the account amount of fluid used in one function from actuation to completion. Open/closure count may refer to the number of times the piece of hydraulic equipment/hydraulic equipment has been opened/closed. Actuation duration may refer to the amount of time for which the piece of hydraulic equipment/hydraulic equipment is actuated. Temperature may refer to temperature within and/or around the piece of hydraulic equipment/hydraulic equipment. Use of other operating characteristics is contemplated.

The sensor information may characterize an operating characteristic of a piece of hydraulic equipment by including information that defines, describes, delineates, identifies, is associated with, quantifies, reflects, sets forth, and/or otherwise characterizes one or more of value, property, quality, quantity, attribute, feature, and/or other aspects of the operating characteristic of the piece of hydraulic equipment. The sensor information may directly and/or indirectly characterize an operating characteristic of a piece of hydraulic equipment. For example, the sensor information may characterize an operating characteristic of a piece of hydraulic equipment by including information that specifies the type and/value of the operating characteristic and/or information that may be used to determine the type and/or value of operating characteristic. Other types of well operation information are contemplated.

The status component 104 may be configured to obtain status information for the piece of hydraulic equipment and/or other information. Obtaining status information may include one or more of accessing, acquiring, analyzing, determining, examining, generating, identifying, loading, locating, measuring, opening, receiving, retrieving, reviewing, selecting, storing, and/or otherwise obtaining the status information. The status component 104 may obtain status information from one or more locations. For example, the status component 104 may obtain status information from a storage location, such as the electronic storage 13, electronic storage of a device accessible via a network, and/or other locations. The status component 102 may obtain status information from one or more hardware components (e.g., a computing device, a sensor) and/or one or more software components (e.g., software running on a computing device).

In some implementations, the status information may be obtained from one or more users. For example, a user may interact with a computing device to input the status information (e.g., upload the status information, specify the status of the piece of hydraulic equipment). In some implementations, the status information may be obtained from one or more sensors. For example, the status component 104 may operate one or more sensors to acquire the status information and/or receive the status information from the sensor(s).

The status information may characterize status of the piece of hydraulic equipment over a period of time. The status information may characterize status of the piece of hydraulic equipment at different moments within the period of time. For example, the status information may include time-series identification/description of the status of the piece of hydraulic equipment at different time points over the period of time.

The status information may characterize status of the piece of hydraulic equipment by defining, describing, identifying, quantifying, reflecting, and/or otherwise characterizing the status of the piece of hydraulic equipment. Status of the piece of hydraulic equipment may refer to state, condition, health, remaining life, defects, and/or prediction on future usage of the piece of hydraulic equipment. For example, status of the piece of hydraulic equipment may include physical condition of the piece of hydraulic equipment (e.g., rubber good degradation, weight, geometry, % washout, etc.), how much useful life is remaining in the piece of hydraulic equipment, how much longer the piece of hydraulic equipment may be used, and/or percentage health value of the piece of hydraulic equipment.

The model component 106 may be configured to generate an equipment health model for the piece of hydraulic equipment. Generating an equipment health model may include constructing, creating, designing, making, producing, and/or otherwise generating the equipment health model. The equipment health model for the piece of hydraulic equipment may be generated based on the sensor information, the status information, and/or other information.

The equipment health model may be generated based on fingerprints/signatures of sensor information/operating characteristics that indicate specific status of the piece of hydraulic equipment. A fingerprint/signature of sensor information/operating characteristics may refer to a specific values of sensor information/operating characteristics and/or specific combination of values of sensor information/operating characteristics that are associated with/indicative of specific status of the piece of hydraulic equipment. A fingerprint/signature of sensor information/operating characteristics may refer to a specific patterns/trends in values of sensor information/operating characteristics and/or specific combination of patterns/trends in values of sensor information/operating characteristics that are associated with/indicative of specific status of the piece of hydraulic equipment.

As the status of the piece of hydraulic equipment changes over time, the sensor information/operating characteristics of the piece of hydraulic equipment may change. Different fingerprints/signatures of sensor information/operating characteristics may exist for different states, different conditions, different health, different remaining life, and/or different defects in the piece of hydraulic equipment. For example, different pressure and acoustic trends may be found for brand new rubber part versus fatigued rubber part versus rubber part with particular defects. The equipment health model may be generated based on historical matches in fingerprints/signatures of sensor information/operating characteristics with different status of the piece of hydraulic equipment.

In some implementations, the equipment health model may include one or more regression models, one or more machine-learning models, and/or other models. The regression model(s) may be generated based on known relationship(s) between the operating characteristics and the status of the piece of hydraulic equipment, such as based on specific values and/or specific combination of values of operating characteristics indicating specific status of the piece of hydraulic equipment or specific patterns/trends in values and/or specific combination of patterns/trends in values of operating characteristics indicating specific status of the piece of hydraulic equipment.

The machine-learning model(s) may be trained based on the operating characteristics and the status of the piece of hydraulic equipment to discover relationship(s) between the operating characteristics and the status of the piece of hydraulic equipment. For example, the machine-learning model(s) may be trained to output specific status of the piece of hydraulic equipment based on specific values and/or specific combination of values of operating characteristics and/or specific patterns/trends in values and/or specific combination of patterns/trends in values of operating characteristics.

The equipment health model may receive as input the operating characteristic(s) of the piece of hydraulic equipment. The equipment health model may provide as output the status of the piece of hydraulic equipment. The equipment health model may identify specific fingerprint/signatures in the operating characteristic(s) of the piece of hydraulic equipment to determine the status of the piece of hydraulic equipment. For example, specific patterns/trends in the operating characteristic(s) of the piece of hydraulic equipment are used as leading indicator of the health of the piece of hydraulic equipment. The equipment health model may determine current health of the piece of hydraulic equipment and/or predict/forecast the health of the piece of hydraulic equipment in the future. The equipment health model may output the status of the piece of hydraulic equipment with a confidence interval.

The storage component 108 may be configured to store the equipment health model for the piece of hydraulic equipment. The equipment health model for the piece of hydraulic equipment may be stored in a storage medium, such as in one or more non-transient storage media and/or other storage media. For example, the storage component 108 may store the equipment health model/information defining the equipment health model in a storage location, such as the electronic storage 13, electronic storage of a device accessible via a network, and/or other locations. The equipment health model may be stored for use in health monitoring for the piece of hydraulic equipment. The equipment health model may be stored for use in quantifying, estimating, and/or predicting the status of the piece of hydraulic equipment. The equipment health model may be stored for retrieval/running to perform health monitoring for the piece of hydraulic equipment.

The usage component 110 may be configured to obtain usage information for the piece of hydraulic equipment and/or other information. Obtaining usage information may include one or more of accessing, acquiring, analyzing, determining, examining, generating, identifying, loading, locating, measuring, opening, receiving, retrieving, reviewing, selecting, storing, and/or otherwise obtaining the usage information. The usage component 110 may obtain usage information from one or more locations. For example, the usage component 110 may obtain usage information from a storage location, such as the electronic storage 13, electronic storage of a device accessible via a network, and/or other locations. The usage component 110 may obtain usage information from one or more hardware components (e.g., a computing device, a sensor) and/or one or more software components (e.g., software running on a computing device).

In some implementations, the usage information may be obtained from one or more users. For example, a user may interact with a computing device to input the usage information (e.g., upload the usage information, specify the operating characteristics of the piece of hydraulic equipment).

In some implementations, the usage information may be obtained from one or more sensors. For example, the usage component 110 may operate one or more sensors to acquire the usage information and/or receive the usage information from the sensor(s). The sensor(s) may include pressure sensor(s), fluid flow rate sensor(s), fluid volume sensor(s), temperature sensor(s), sound sensor(s), and/or other sensors.

The usage information may characterize the operating characteristic(s) of the piece of hydraulic equipment for a duration of time. The usage information may characterize operating characteristic(s) of the piece of hydraulic equipment at different moments within the duration of time. For example, the usage information may include time-series measurements of the operating characteristic(s) of the piece of hydraulic equipment at different time points over the duration of time. The usage information may characterize same operating characteristic(s) of the price of hydraulic equipment as the sensor information. The usage information may include the same type of information as the sensor information. Other types of usage information are contemplated.

The usage information obtained by the usage component 110 may include real-time usage information. Real-time usage information may refer to usage information that characterizes current characteristic(s), the most recent characteristic(s), or the last measured operating characteristic(s) of the piece of hydraulic equipment. For example, the real-time usage information may characterize the operating characteristic(s) of the piece of hydraulic equipment currently being measured by sensor(s). The real-time usage information may characterize the operating characteristic(s) that have been measured within a threshold amount of time (e.g., operating characteristic(s) measured within the past day/part of the past day). The duration of time for which the usage information characterizes the operating characteristics of the piece of hydraulic equipment may include a set duration of time. The duration of time may be set by the system 10 (e.g., default duration of time) or set by a user (e.g., user-controlled duration of time). For example, the duration of time may include a day or a part of a day or a week or a part of a week. Use of other durations of time is contemplated.

The health component 112 may be configured to input the usage information and/or other information into the equipment health model for the piece of hydraulic equipment. The equipment health model may use the input information to output the status of the piece of hydraulic equipment and/or other information. The health component 112 inputting the usage information into the equipment health model may include providing the usage information and/or information determined from the usage information to the equipment health model for use as input. For example, the health component 112 may provide the usage information obtained by the usage component 110 to the equipment health model as input. The health component 102 may process/modify the usage information obtained by the usage component 110 before providing the processed/modified usage information to the equipment health model as input.

The equipment health model for the piece of hydraulic equipment may output status of the piece of hydraulic equipment based on the usage information and/or other information. The equipment health model may quantify, estimate, and/or predict the status (e.g., state, condition, health, remaining life, defects, and/or prediction on future usage) of the piece of hydraulic equipment based on the usage information and/or other information. The equipment health model may use fingerprints/signatures found in the usage information to output the status of the piece of hydraulic equipment. Specific patterns/trends in the operating characteristic(s) of the piece of hydraulic equipment may be used as leading indicator to determine the status of the piece of hydraulic equipment.

For example, the piece of hydraulic equipment may include an elastomer component, and the equipment health model may, based on particular fingerprints/signatures found in the usage information, output physical condition of the elastomer component, remaining life of the elastomer component, one or more defects in the elastomer component, prediction on future usage of the elastomer component, and/or other status of the elastomer component. The equipment health model may output current status of the piece of hydraulic equipment and/or future status of the piece of hydraulic equipment.

The monitoring component 114 may be configured to facilitate health monitoring for the piece of hydraulic equipment based on the status of the piece of hydraulic equipment output by the equipment health model and/or other information. Health monitoring for the piece of hydraulic equipment may refer to monitoring state, condition, health, remaining life, defect, and/or prediction on future usage of the piece of hydraulic equipment. The status of the piece of hydraulic equipment output by the equipment health model may be used to monitor changes in the status of the price of hydraulic equipment.

The monitoring component 114 may facilitate use of the status output by the equipment health model to perform health monitoring for the piece of hydraulic equipment. The monitoring component 114 may facilitate use of information relating to and/or determined from the status output by the equipment health model to perform health monitoring for the piece of hydraulic equipment. For example, facilitating health monitoring for the piece of hydraulic equipment may include (1) presenting the status of the piece of hydraulic equipment on the electronic display 14, (2) presenting information relating to and/or determined from the status of the piece of hydraulic equipment on the electronic display 14, (3) presenting results of health monitoring for the piece of hydraulic equipment on the electronic display 14, (4) providing information relating to and/or determined from the status of the piece of hydraulic equipment to one or more health monitoring processes, and/or (5) performing health monitoring for the piece of hydraulic equipment using information relating to and/or determined from the status of the piece of hydraulic equipment.

In some implementations, facilitation of the health monitoring for the piece of hydraulic equipment based on the status of the piece of hydraulic equipment output by the equipment health model may include performance of one or more maintenance operations for the piece of hydraulic equipment based on the status of the piece of hydraulic equipment output by the equipment health model and/or other information. A maintenance operation for the piece of hydraulic equipment may refer to an operation to fix, preserve, replace, restore, and/or otherwise maintain the piece of hydraulic equipment. Performing a maintenance operation may include carrying out, scheduling, initiating, and/or otherwise performing the maintenance operation. For example, based on the percentage health value or remaining life of an elastomer component, a maintenance operation to replace the old elastomer component with a new elastomer component may be scheduled and carried out. Other types of maintenance operation are contemptible.

In some implementations, facilitation of the health monitoring for the piece of hydraulic equipment based on the status of the piece of hydraulic equipment output by the equipment health model may include generation of one or more alerts and/or one or more alarms. The alerts/alarms may be generated to inform personnel of issues with the piece of hydraulic equipment. The alerts/alarms may be escalated to personnel to ensure the equipment health is proactively addressed.

In some implementations, presenting the status of the piece of hydraulic equipment on the electronic display 14 may include generating and displaying a visual/graphical representation of the status of the piece of hydraulic equipment on the electronic display 14. For example, the status of the piece of hydraulic equipment may be presented using one or more numbers (e.g., percentage health value), one or more characters/words (e.g., new, low/medium/high fatigue), one or more colors (e.g., green, yellow, red), and/or other visual/graphical representation.

In some implementations, presenting the status of the piece of hydraulic equipment on the electronic display 14 may include generating and displaying a visual/graphical representation of changes in the status of the piece of hydraulic equipment on the electronic display 14. For example, changes in the percentage health value of the piece of hydraulic equipment as a function of time and/or operation performed may be generated and displayed. Such visual/graphical representation of changes in the status of the piece of hydraulic equipment may be used to determine the impact of different operations on the status of the piece of hydraulic equipment. Such visual/graphical representation of changes in the status of the piece of hydraulic equipment may be used to modify/avoid certain operations to reduce the amount of fatigue on the piece of hydraulic equipment.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

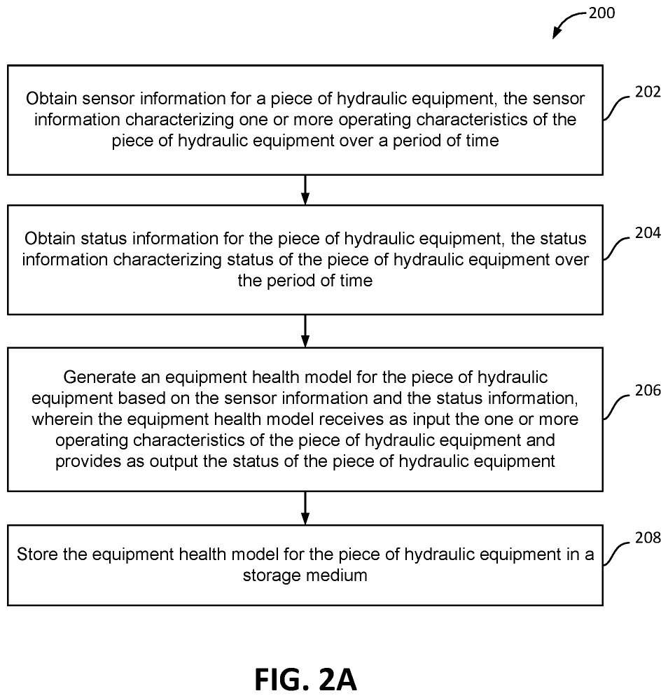

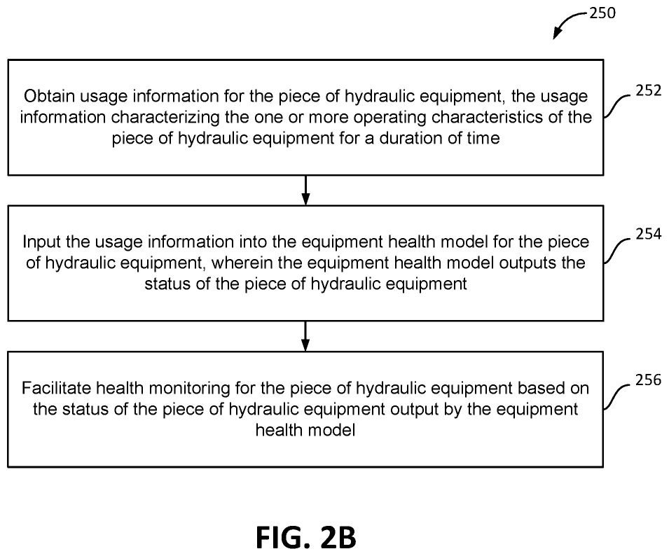

FIGS. 2A and 2B illustrate methods 200, 250 for monitoring health of hydraulic equipment components. The operations of methods 200, 250 presented below are intended to be illustrative. In some implementations, methods 200, 250 may be accomplished with one or more additional operations not described, and/or without one or more of the operations discussed. In some implementations, two or more of the operations may occur substantially simultaneously.

In some implementations, methods 200, 250 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2A and method 200, at operation 202, sensor information for a piece of hydraulic equipment may be obtained. The sensor information may characterize one or more operating characteristics of the piece of hydraulic equipment over a period of time. In some implementations, operation 202 may be performed by a processor component the same as or similar to the sensor component 102 (Shown in FIG. 1 and described herein).

At operation 204, status information for the piece of hydraulic equipment may be obtained. The status information may characterize status of the piece of hydraulic equipment over the period of time. In some implementations, operation 204 may be performed by a processor component the same as or similar to the status component 104 (Shown in FIG. 1 and described herein).

At operation 206, an equipment health model for the piece of hydraulic equipment may be generated based on the sensor information, the status information, and/or other information. The equipment health model may receive as input the operating characteristic(s) of the piece of hydraulic equipment. The equipment health model may provide as output the status of the piece of hydraulic equipment. In some implementations, operation 206 may be performed by a processor component the same as or similar to the model component 106 (Shown in FIG. 1 and described herein).

At operation 208, the equipment health model for the piece of hydraulic equipment may be stored in a storage medium. In some implementations, operation 208 may be performed by a processor component the same as or similar to the storage component 108 (Shown in FIG. 1 and described herein).

Referring to FIG. 2B and method 250, at operation 252, usage information for the piece of hydraulic equipment may be obtained. The usage information may characterize the operating characteristic(s) of the piece of hydraulic equipment for a duration of time. In some implementations, operation 252 may be performed by a processor component the same as or similar to the usage component 110 (Shown in FIG. 1 and described herein).

At operation 254, the usage information may be input into the equipment health model for the piece of hydraulic equipment, and the equipment health model may output the status of the piece of hydraulic equipment. In some implementations, operation 254 may be performed by a processor component the same as or similar to the health component 112 (Shown in FIG. 1 and described herein).

At operation 256, health monitoring for the piece of hydraulic equipment based on the status of the piece of hydraulic equipment output by the equipment health model may be facilitated. In some implementations, operation 256 may be performed by a processor component the same as or similar to the monitoring component 114 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for monitoring health of hydraulic equipment components, the system comprising:
one or more physical processors configured by machine-readable instructions to:
obtain sensor information for a piece of hydraulic equipment, the sensor information characterizing one or more operating characteristics of the piece of hydraulic equipment over a period of time;
obtain status information for the piece of hydraulic equipment, the status information characterizing status of the piece of hydraulic equipment over the period of time;
generate an equipment health model for the piece of hydraulic equipment based on the sensor information and the status information, wherein the equipment health model receives as input the one or more operating characteristics of the piece of hydraulic equipment and provides as output the status of the piece of hydraulic equipment; and
store the equipment health model for the piece of hydraulic equipment in a storage medium.

2. The system of claim 1, wherein the one or more physical processors are further configured by the machine-readable instructions to:
obtain usage information for the piece of hydraulic equipment, the usage information characterizing the one or more operating characteristics of the piece of hydraulic equipment for a duration of time;
input the usage information into the equipment health model for the piece of hydraulic equipment, wherein the equipment health model outputs the status of the piece of hydraulic equipment; and
facilitate health monitoring for the piece of hydraulic equipment based on the status of the piece of hydraulic equipment output by the equipment health model.

3. The system of claim 2, wherein facilitation of the health monitoring for the piece of hydraulic equipment based on the status of the piece of hydraulic equipment output by the equipment health model includes performance of one or more maintenance operations for the piece of hydraulic equipment based on the status of the piece of hydraulic equipment output by the equipment health model.

4. The system of claim 1, wherein the equipment health model includes a regression model and/or a machine-learning model.

5. The system of claim 1, wherein the one or more operating characteristics of the piece of hydraulic equipment include pressure, fluid flow rate, fluid volume, open/closure count, actuation duration, and temperature.

6. The system of claim 5, wherein the one or more operating characteristics of the piece of hydraulic equipment further include sound.

7. The system of claim 1, wherein:
the piece of hydraulic equipment includes an elastomer component; and
the status of the piece of hydraulic equipment including status of the elastomer component.

8. The system of claim 7, wherein the status of the elastomer component includes remaining life of the elastomer component.

9. The system of claim 7, wherein the status of the elastomer component includes one or more defects in the elastomer component.

10. The system of claim 7, wherein the status of the elastomer component includes prediction on future usage of the elastomer component.

11. A method for monitoring health of hydraulic equipment components, the method comprising:
obtaining sensor information for a piece of hydraulic equipment, the sensor information characterizing one or more operating characteristics of the piece of hydraulic equipment over a period of time;
obtaining status information for the piece of hydraulic equipment, the status information characterizing status of the piece of hydraulic equipment over the period of time;
generating an equipment health model for the piece of hydraulic equipment based on the sensor information and the status information, wherein the equipment health model receives as input the one or more operating characteristics of the piece of hydraulic equipment and provides as output the status of the piece of hydraulic equipment; and
storing the equipment health model for the piece of hydraulic equipment in a storage medium.

12. The method of claim 11, wherein further comprising:
obtaining usage information for the piece of hydraulic equipment, the usage information characterizing the one or more operating characteristics of the piece of hydraulic equipment for a duration of time;
inputting the usage information into the equipment health model for the piece of hydraulic equipment, wherein the equipment health model outputs the status of the piece of hydraulic equipment; and
facilitating health monitoring for the piece of hydraulic equipment based on the status of the piece of hydraulic equipment output by the equipment health model.

13. The method of claim 12, wherein facilitating the health monitoring for the piece of hydraulic equipment based on the status of the piece of hydraulic equipment output by the equipment health model includes performing one or more maintenance operations for the piece of hydraulic equipment based on the status of the piece of hydraulic equipment output by the equipment health model.

14. The method of claim 11, wherein the equipment health model includes a regression model and/or a machine-learning model.

15. The method of claim 11, wherein the one or more operating characteristics of the piece of hydraulic equipment include pressure, fluid flow rate, fluid volume, open/closure count, actuation duration, and temperature.

16. The method of claim 15, wherein the one or more operating characteristics of the piece of hydraulic equipment further include sound.

17. The method of claim 11, wherein:
the piece of hydraulic equipment includes an elastomer component; and
the status of the piece of hydraulic equipment including status of the elastomer component.

18. The method of claim 17, wherein the status of the elastomer component includes remaining life of the elastomer component.

19. The method of claim 17, wherein the status of the elastomer component includes one or more defects in the elastomer component.

20. The method of claim 17, wherein the status of the elastomer component includes prediction on future usage of the elastomer component.
